(19) United States
(12) Patent Application Publication
(10) Pub. No.: US 2013/0145053 A1
(43) Pub. Date: Jun. 6, 2013

(54) METHOD AND SYSTEM FOR RECOGNIZING ACCESSORY IN PORTABLE TERMINAL

(71) Applicant: Samsung Electronics Co., Ltd., Suwon-si (KR)

(72) Inventors: Taekwan CHA, Suwon-si (KR); Yongsang YUN, Suwon-si (KR)

(73) Assignee: SAMSUNG ELECTRONICS CO. LTD., Suwon-si (KR)

(21) Appl. No.: 13/688,826

(22) Filed: Nov. 29, 2012

(30) Foreign Application Priority Data
Dec. 1, 2011 (KR) 10-2011-0127549

(51) Int. Cl. G06F 3/16

(52) U.S. Cl. CPC G06F 3/162
USPC 710/16

(57) ABSTRACT

A method and a system for recognizing an accessory in a portable terminal are provided. The system for the recognizing of the accessory includes the accessory which is connected to a portable terminal through a first Universal Serial Bus (USB) interface unit, and an auxiliary accessory connected to the accessory through a second USB interface unit or a ear jack interface unit, wherein the portable terminal senses a connection of the auxiliary accessory to the accessory according to a voltage variation of an identification terminal of a third accessory USB interface unit which is connected to the first USB interface unit.

### PRIORITY

This application claims the benefit under 35 U.S.C. §119(a) of a Korean patent application filed on Dec. 1, 2011 in the Korean Intellectual Property Office and assigned Serial No. 10-2011-0127549, the entire disclosure of which is hereby incorporated by reference.

### BACKGROUND OF THE INVENTION

1. Field of the Invention

The present invention relates to a method and a system for recognizing an accessory in a portable terminal. More particularly, the present invention relates to a method and a system for recognizing an accessory, or in other words, determining an accessory, in a portable terminal which may recognize connection of an auxiliary accessory to an accessory connected through a Universal Serial Bus (USB) interface.

2. Description of the Related Art

In recent years, with the significant development of information and communication technology and a semiconductor technology, supply and use of portable terminals has rapidly increased. In particular, portable terminals may provide mobile convergence services, including traditional voice communications, messaging, and data services as well as other services that may be provided on portable terminals. Furthermore, in recent years, portable terminals, which may also be referred to as mobile communication terminals, provide various functions such as a TeleVision (TV) viewing service, such as mobile broadcasting using Digital Multimedia Broadcasting (DMB) or Digital Video Broadcasting (DVB)), a music playing function, such as a Motion Picture Experts Group (MPEG) Audio Layer-3 (MP3) music service, a photographing function, and an Internet access function as well as a general communications functions, such as a speech call or message transmission/reception.

Further developments in mobile convergence allow for a portable terminal providing and/or having an accessory, such as a docking station, which may be a multimedia dock, a laptop dock, or the like, and use of docking stations has increased. In general, the portable terminal and the accessory are connected to each other through a Universal Serial Bus (USB) interface. An auxiliary accessory such as an earphone, a speaker, a headset, a keyboard, a mouse, or the like, may be connected to the accessory. However, a portable terminal may not recognize that the auxiliary accessory is connected to the accessory. The reason is because a signal line for recognizing an auxiliary accessory is not provided according to use of the USB interface. For example, although an earphone is connected to the docking station, the portable terminal, connected to the docking station via the USB interface, may not recognize it. Owing to this, a user of the portable terminal may need to configure the portable terminal such that an audio signal is output to the earphone using a menu or the like of the portable terminal Furthermore, the accessory may include a plurality of keys. However, as the portable terminal is connected to an accessory, such as the docking station, through a USB interface, the portable terminal may not recognize a key input included in the accessory. This is because the USB interface does not include a signal line for key recognition. Accordingly, there is a need for a portable terminal that recognizes an auxiliary accessory connected to an accessory of the portable terminal.

### SUMMARY OF THE INVENTION

Aspects of the present invention are to address at least the above-mentioned problems and/or disadvantages and to provide at least the advantages described below. Accordingly, an aspect of the present invention is to provide a method and a system for recognizing an accessory in a portable terminal which may sense a connection of the accessory and an auxiliary accessory via a Universal Serial Bus (USB) interface.

Another aspect of the present invention is to provide a method and a system for recognizing an accessory in a portable terminal which determines a type of an auxiliary accessory connected to the accessory via a USB interface, and automatically executes a function corresponding to the determined type of the auxiliary accessory.

Another aspect of the present invention is to provide a method and a system for recognizing an accessory in a portable terminal which may recognize a key input included in the accessory via the USB interface.

In accordance with an aspect of the present invention, a system for recognizing an accessory is provided. The system includes the accessory which is connected to a portable terminal through a first Universal Serial Bus (USB) interface unit, and an auxiliary accessory connected to the accessory through a second USB interface unit or a ear jack interface unit, wherein the portable terminal senses a connection of the auxiliary accessory to the accessory according to a voltage variation of an identification terminal of a third accessory USB interface unit which is connected to the first USB interface unit.

In accordance with another aspect of the present invention, a method for recognizing an accessory in a portable terminal to which the accessory is connected via a Universal Serial Bus (USB) interface unit is provided. The method includes sensing a connection of the accessory through an identification terminal of the USB interface unit and sensing a connection of an auxiliary accessory according to a voltage variation of the identification terminal when the accessory is connected to the portable terminal

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a system according to an exemplary embodiment of the present invention;

FIG. 2 is a diagram illustrating configurations of a portable terminal and an accessory according to an exemplary embodiment of the present invention;

FIG. 3A is a diagram illustrating an equivalent circuit when an auxiliary accessory is not connected according to an exemplary embodiment of the present invention;

FIG. 3B is a diagram illustrating an equivalent circuit when an auxiliary accessory is connected according to an exemplary embodiment of the present invention; and

FIG. 4 is a flowchart illustrating a method for recognizing an accessory in a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a portable terminal according to an exemplary embodiment of the present invention may be an electronic device capable of being connected to an accessory through a Universal Serial Bus (USB) interface unit, and may include any one of or a combination of a mobile communication terminal, a Personal Digital Assistants (PDA), a Smart Phone, a Tablet Personal Computer (PC), a Portable Multimedia Player (PMP), and any other suitable and/or similar electronic device. Additionally, hereinafter, the term “auxiliary accessory” refers to an accessory connected to the accessory. The auxiliary accessory may be connected through an ear jack interface unit, a USB interface unit, or any other suitable and/or similar interface unit or connection unit.

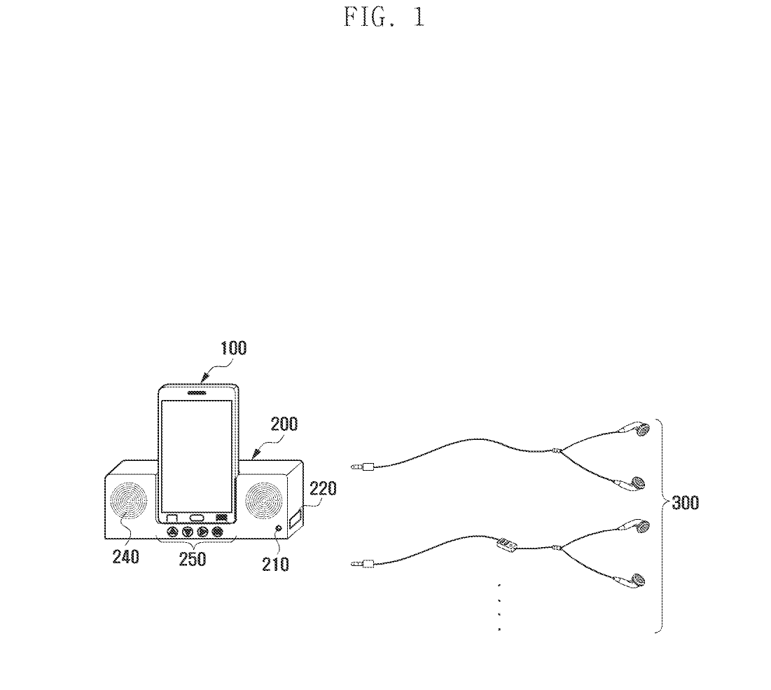

FIG. 1 is a diagram illustrating a system according to an exemplary embodiment of the present invention.

Referring to FIG. 1, a portable terminal 100 may be mounted in a docking station 200, the docking station 200 being an accessory. The portable terminal 100 may be connected to the docking station 200 through a first USB unit (not shown) of the docking station 200. An auxiliary accessory 300 may be connected through an ear jack interface unit 210 or a second USB interface unit 220. The auxiliary accessory 300 may become an earphone, a keyboard, a mouse, speaker, a headset, or any other similar and/or suitable device.

The docking station 200 may include a first USB interface (not shown) connected to the portable terminal 100, the ear jack interface unit 210, and the second USB interface unit 220 connected to the auxiliary accessory 300. Furthermore, the docking station 200 may also include a speaker 240 for outputting an audio signal and a key input unit 250 having at least one key.

The portable terminal 100 may sense or detect a connection to and a type of the accessory 200 through an identification terminal Particularly, the portable terminal 100, according to the present exemplary embodiment, may detect a connection of the auxiliary accessory 300 with the docking station 200 through an identification terminal of a third USB interface unit (not shown). The portable terminal 100 may also determine an output voltage of the identification terminal in order to recognize a type of the connected auxiliary accessory 300, and may automatically execute a function that is set to be corresponding to the recognized type of the auxiliary accessory. For example, when a connection of an earphone with the ear jack interface unit 210 is sensed or detected, the portable terminal 100 may control an audio signal such that the audio signal is not output to the speaker 240.

Furthermore, the portable terminal 100 may sense or detect input of the key input unit 250 through the identification terminal of a third USB interface unit (not shown). For example, when a next music piece playback key signal is input from the key input unit 250 during playback of a music file, the portable terminal 100 may play a next music piece. Thus, the present exemplary embodiment may control the portable terminal 100 through the key input unit 250 included in the docking station 200 to improve convenience for a user. However, the present invention is not limited thereto, and the portable terminal 100 may be controlled through any suitable control unit, input unit, and user input.

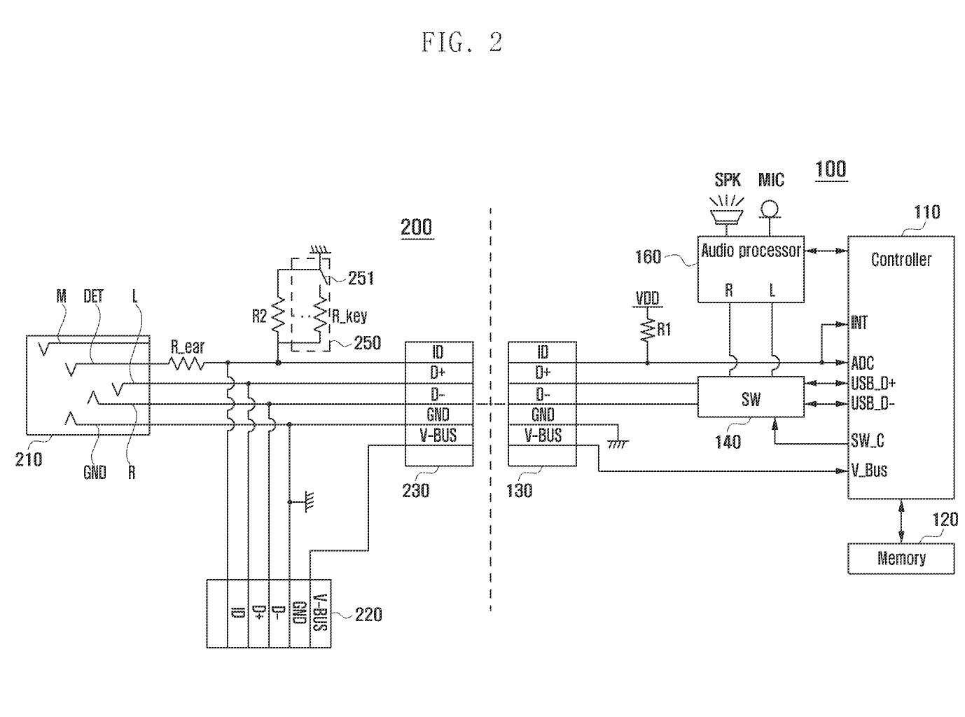

FIG. 2 is a diagram illustrating configurations of a portable terminal and an accessory according to an exemplary embodiment of the present invention.

Referring to FIGS. 1 and 2, the accessory 200 may include an ear jack interface unit 210, a first USB interface unit 230, a second USB interface unit 220, and a key input 250. The first USB interface unit 230 is for connecting to the portable terminal 100, and may include an IDentification (ID) terminal, a positive data terminal D+, a negative terminal D−, a ground terminal GND, and a power terminal V_BUS. Particularly, the ID terminal of the first USB interface unit 230 is connected to a detection terminal DET of the ear jack interface unit 210 through an earphone recognition resistor R_ear, and a pull-down resistor R2 may be located between the earphone recognition resistor R_ear and the ID terminal of the first USB interface unit 230.

An auxiliary accessory 300 may be connected to the second USB interface unit 220. The auxiliary accessory 300 may be a variety of types and/or devices, including, a USB keyboard, a USB mouse, or any other similar or suitable device, may be connected to the second USB interface unit 220. The second USB interface unit 220 includes an ID terminal, a positive data terminal D+, a negative data terminal D−, a ground terminal GND, and a power terminal V_BUS, and each terminal may be connected to a corresponding terminal of the first USB interface unit 230. An earphone of the auxiliary accessory 300 may be connected to the ear jack interface unit 210. A detection terminal DET of the ear jack interface unit 210 may be connected to an ID terminal of the first USB interface unit 230 and an ID terminal of the second USB interface unit 220. When an earphone is not connected, the detection terminal DET of the ear jack interface unit 210 may be open, or in other words, may be an open circuit. Conversely, when the earphone is connected, the detection terminal DET of the ear jack interface unit 210 may be grounded.

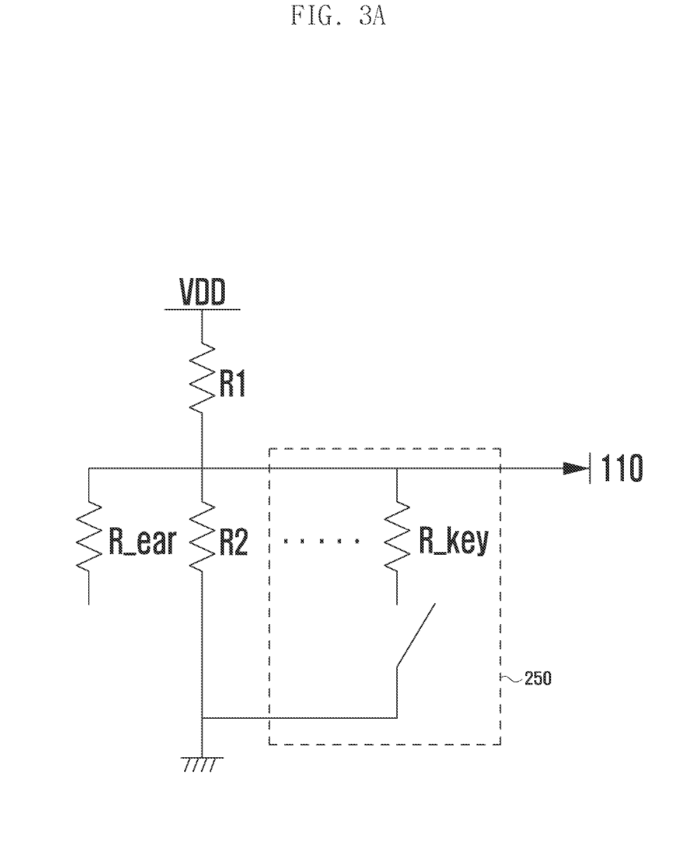

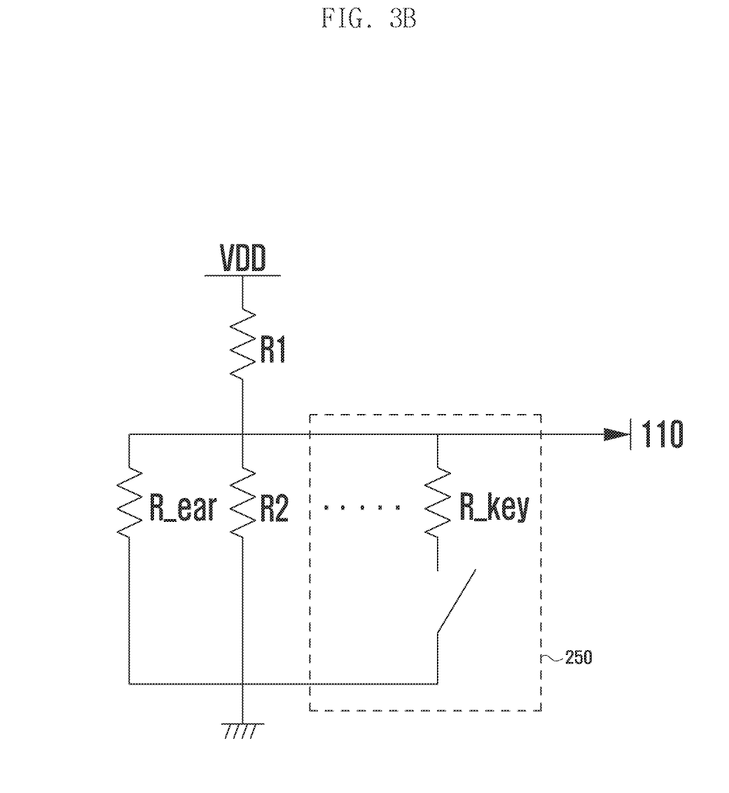

The key input unit 250 may include the pull-down resistor R2, a plurality of key resistors R_key, and a switch 251 connected to the pull-down resistor R2 in parallel. When a user pushes a key, the switch 251 is pressed so as to ground the key resistors R_key. In this case, a voltage applied to the ID terminal of the first USB interface unit 230 may vary. Accordingly, the controller 110 may recognize the user's key push through the variation in the voltage of the ID terminal and may recognize a type of the pushed key based on the voltage. That is, when a plurality of keys are provided, different resistances are allotted to respective keys so as to distinguish the keys from each other. The key input unit 250 will be described in detail with reference to FIGS. 3A and 3B below.

Referring further to FIG. 2, the portable terminal 100 may include an audio processor 160, a switch unit 140, a third USB interface unit 130, a memory 120, and a controller 110.

The audio processor 160 may be configured by an acoustic component for transmitting and/or receiving an audio signal to perform encoding and decoding. The audio processor 160 may include, although not shown, a codec, an audio amplifier, and other similar and suitable audio processing elements. The audio processor 160 is connected to a microphone MIC and a speaker SPK. The audio processor 160 may convert a speech signal input from the microphone MIC into data, and transmit the data to the controller 110. The audio processor 160 may convert a speech signal input from the controller 110 into an analog signal, and output the analog signal through the speaker SPK. Furthermore, the audio processor 160 may output various audio signals and/or audio file formats, such as Motion Picture Experts Group (MPEG) Audio Layer 3 (MP3) files, an audio signal according to playback of moving image files, or other similar file types and signals, generated from the portable terminal 100 through the speaker SPK. In particular, the audio processor 160 may transmit an audio signal to the accessory 200 and the auxiliary accessories 300 through the third USB interface unit 130 under control of the controller 110.

The switch unit 140 may switch an audio signal and a USB signal. For example, in order to transmit an audio signal to the accessory 200 through the third USB interface unit 130, the switch 140 may respectively connect data lines D+ and D− of the third USB interface unit 130 to acoustic terminals R and L of the audio processor 160. Alternatively, in order to perform USB communication with the accessory 200 through the third USB interface unit 130, the switch unit 140 may respectively connect data lines D+ and D− of the third USB interface unit 130 to USB terminals USB D+ and USB D− of the controller 160.

The third USB interface unit 130 is an interface unit for connection with the accessory 200, and may include an ID terminal, a positive data terminal D+, a negative terminal D−, a ground terminal GND, and a power terminal V_BUS. Power VDD may be supplied to the ID terminal of the third USB interface unit 130 through a pull-up resistor R1.

The memory 120 may store an Operating System (OS) of the portable terminal 100, application programs used for other optional functions, for example, a sound playback function, an image or moving image playback function, a broadcasting playback function, and the like, user data, and transmitted and/or received data during communication functions. Furthermore, the memory 120 may store a character message, a game file, a music file, a movie file, a contact point, user data, and other similar types of data and information. Particularly, the memory 120, according to the present exemplary embodiment, may store an application program for controlling connection sensing of the accessory 200, type recognition of the accessory 200, connection recognition of the auxiliary accessory 300, type recognition of the auxiliary accessory 300, key push recognition, and key type recognition, through an output voltage of the ID terminal of the third USB interface unit 130. Moreover, the memory 120 may store an accessory recognition table, a key recognition table, and an auxiliary accessory recognition table, which are used when recognizing the accessory 200, the auxiliary accessory 300, and the key. In this case, the auxiliary accessory recognition table may be changed according to a type of a connected accessory. Moreover, the key recognition table may be changed according to a type of accessory and a type of auxiliary accessory.

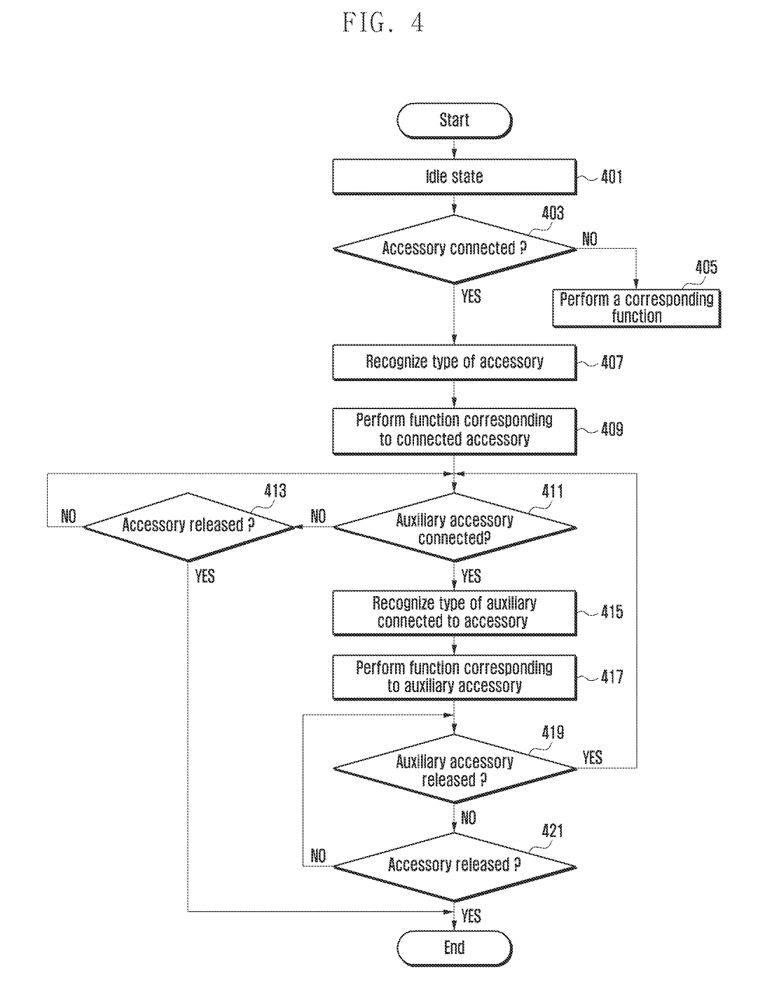

The controller 110 may control an overall operation of the portable terminal 100 and signal flow between internal blocks of the portable terminal 100, and may also perform a data processing function for processing data. Particularly, the controller 110 may control connection and type sensing of the accessory 200, connection and type sensing of the auxiliary 300, and key recognition of the accessory 200. The controller 110 will be described below with reference to FIG. 4.

Although not shown in FIG. 2, the portable terminal 100 of the present exemplary embodiment may selectively include structural elements with additional functions, such as a camera module for photographing images or moving images, a near distance communication module for near distance wireless communication, such as Near Field Communication (NFC), a broadcasting receiving module for receiving broadcasting, a digital sound source playback module, such as an MP3 module, and an Internet communication module for performing an Internet function. However, the present invention is not limited thereto, since the structural elements may be variously changed according to a convergence trend of a digital device, and the portable terminal 100 may including any suitable or similar structural elements.

FIG. 3A is a diagram illustrating an equivalent circuit when an auxiliary accessory is not connected according to an exemplary embodiment of the present invention. FIG. 3B is a diagram illustrating an equivalent circuit when an auxiliary accessory is connected according to an exemplary embodiment of the present invention.

Referring to FIGS. 1 to 3B, when the accessory 200 is not connected, a voltage corresponding to a power source VDD is input to an interrupt terminal INT and an Analog-Digital Converter (ADC), both of the controller 110, as shown in FIG. 2. Next, when the accessory 200 is connected to the portable terminal 100, as shown in FIG. 3A, a voltage corresponding the power VDD is divided by a resistance ratio of a pull-up resistor R1 and a pull-down resistor R2, and the divided voltage is input to the interrupt terminal INT and the ADC of the controller 110. For example, when the voltage corresponding to the power VDD is 3.0V, resistance of the pull-up resistor R1 is 10 kΩ, resistance of the pull-up resistor R2 is 5 kΩ, and thus, a voltage of 1V is input to the interrupt terminal INT and the ADC of the controller 110. The controller 110 may sense that the accessory 200 is connected through a voltage variation from 3V to 1V, and compare the voltage variation with an accessory recognition table stored in the memory 120 in order to recognize that an accessory corresponding to 1V is connected.

Furthermore, when a key is pushed in a state, as shown in FIG. 3A, the key R_key may be connected to a ground. That is, the voltage corresponding to the power VDD may be divided by a resistance ratio of the pull-up resistor R1 and a composite resistance between the pull-down resistor R2 and the key resistor R_key, and the divided voltage is input to the interrupt terminal INT and the ADC of the controller 110. That is, when the key is pushed, the voltage input to the interrupt terminal INT and the ADC may vary. In this case, the controller 110 may recognize a key push and a type of the pushed key with reference to the stored key recognition table.

Meanwhile, when an earphone is connected to an ear jack interface unit 210 of the accessory 200, as shown in FIG. 3B, the earphone recognition resistor R_ear may be grounded. That is, when the earphone is connected to the ear jack interface unit 210, the voltage corresponding to the power VDD divided by a resistance ratio of the pull-up resistor R1 and a composite resistance between the pull-down resistor R2 and the earphone recognition resistor R_ear, and the divided voltage is then input to the interrupt terminal INT and the ADC of the controller 110. Through the voltage variation, the controller 110 may sense connection of the auxiliary accessory 300 and recognize a type of auxiliary accessory 300 based on the voltage variation.

When the key is pushed in a state where the auxiliary accessory 300 is connected to the accessory 200, the voltage input to the interrupt terminal INT and the ADC has another value which is different from the value of the INT and ADC illustrated in FIG. 3A. Accordingly, the present exemplary embodiment changes the key recognition table according to presence of connection of the auxiliary accessory 300 and a type of the auxiliary accessory 300.

FIG. 4 is a flowchart illustrating a method for recognizing an accessory in a portable terminal according to an exemplary embodiment of the present invention.

Referring to FIGS. 1 to 4, a controller 110 of a portable terminal 100 may be in an idle state at step 401. Next, the controller 110 may determine whether an accessory 200 is connected through a third USB interface unit 130 in step 403. The connection of the accessory 200 may be sensed through an interrupt signal generated from an ID terminal of the third USB interface unit 130, as illustrated in FIGS. 3A and 3B. To do this, the controller 110 may include an interrupt terminal INT sensing the interrupt signal.

When the controller 110, in step 403, determines that the accessory 200 is not connected, then the controller 110 may perform a corresponding function in step 405. For example, the controller 110 may perform a music playback function, a moving image playback function, a call function, and any other similar function, or may maintain the idle state. Conversely, when the controller 110, in step 403, determines that the accessory 200 is connected, then the controller 110 may recognize a type of the connected accessory in step 407. The controller 110 may determine an output voltage of the ID terminal of the third USB interface unit 130 and recognize a type of the connected accessory according to the determined voltage. To do this, the controller 110 may include an ADC, and the memory 120 may store the accessory recognition table, as discussed above.

When the recognition of the type of the accessory 200 is completed in step 407, the controller 110 may perform a function corresponding to the connected accessory 200 in step 409. That is, in a case where the accessory 200 includes a speaker 240, the controller 110 may control an audio signal output from the audio processor 160 such that the audio signal is output through the speaker 240 of the accessory 200. Additionally, the controller 110 may control the audio signal such that it is output to both of the speaker SPK of the portable terminal 100 and the speaker 240 of the accessory 200. Furthermore, when a key signal is inputted from the accessory 200, the controller 110 may execute a function corresponding to the key signal in step 409. The key signal may be input through the ID terminal of the third USB interface unit 130. In this case, the portable terminal 100 may store the key recognition table in the memory 120, as discussed above. The key recognition table may be changed according to a type of the accessory 200.

The controller 110 may determine whether an auxiliary accessory 300 is connected to the accessory 200 in step 411. When a voltage of the ID terminal of the third USB interface unit 130 varies, the controller 110 may determine that the auxiliary accessory 300 is connected. Alternatively, when the controller 110 determines that the auxiliary accessory 300 is not connected in step 411, then the controller 110 may determine whether the connection of the accessory 200 is released in step 413. When the connection of the accessory 200 is not released, the controller 110 returns to step 411. When the connection of the accessory 200 is released, as determined in step 413, then the controller 110 may end the above discussed procedure and may then return to step 401 and/or step 403. Conversely, when the controller 110 determines that the auxiliary accessory 300 is connected, then the controller 110 may recognize a type of the auxiliary 300 connected to the accessory 200 in step 415. As described above, the type of the auxiliary accessory 300 may be recognized through an output voltage of an ID terminal of the third USB interface unit 130. To do this, the memory 120 of the portable terminal 100 may store an auxiliary accessory recognition table. The auxiliary accessory recognition table may be changed according to the type of the connected accessory.

After the type of the auxiliary accessory 300 is recognized in step 415, then the controller 110 may execute a function corresponding to the connected auxiliary accessory 300 in step 417. For example, in a case where the auxiliary accessory 300 is an earphone, that is, when a connection of the earphone is determined through the third USB interface unit 130, the controller 110 may control the audio signal such that it is not output to the speaker SPK of the portable terminal 100 or the speaker 240 of the accessory 200 upon requesting audio output, but rather, is output to an earphone connected to the ear jack interface 210. Furthermore, when a key signal is input from the accessory 200, the controller 110 may perform a function corresponding to the input key signal. To do this, the memory 120 of the portable terminal 100 may store a key recognition table. The key recognition table may be changed according to the type of the auxiliary accessory 300.

Furthermore, the controller 110 may determine whether the connection of the auxiliary accessory 300 is released in step 419. When the connection of the auxiliary accessory 300 is released, the controller 110 may return to step 411. Conversely, when the connection of the auxiliary accessory 300 is not released, as determined in step 419, then the controller 110 may determine whether connection of the accessory 200 is released in step 421. When the connection of the accessory 200 is not released, then the controller 110 may return to step 419. Conversely, when the connection of the accessory 200 is released, then the controller 110 may return to one of step 401 and step 403 and may repeat the forgoing procedures.

The method for recognizing an accessory in a portable terminal according to exemplary embodiments of the present invention, as described above, may be implemented in an executable program command form by various computer means and may be recorded in a non-transient computer readable recording medium. In this case, the non-transient computer readable recording medium may include a program command, a data file, a data structure, either individually or a combination thereof, and any other suitable data storage element. Additionally, the program command recorded in a non-transient recording medium may be specially designed or configured for the present exemplary embodiments or may be known to a person having ordinary skill in a computer software field to be used. The non-transient computer readable recording medium includes Magnetic Media, such as a hard disk, a floppy disk, and a magnetic tape, Optical Media, such as a Compact Disc Read Only Memory (CD-ROM) and a Digital Versatile Disc (DVD), Magneto-Optical Media, such as a floptical disk, and a hardware device, such as a Read Only Memory (ROM), a Random Access Memory (RAM), a flash memory storing and executing program commands, and any other similar and/or suitable non-transient computer readable recording medium. Furthermore, the program command may include a machine language code created by a complier and a high-level language code executable by a computer using an interpreter. The foregoing hardware device may be configured to be operated as at least one software module to perform an operation of the present exemplary embodiments, and a reverse operation thereof is the same.

As mentioned above, the method and the system for recognizing an accessory in a portable terminal according to the present exemplary embodiments of the present invention may sense connection of an accessory and an auxiliary accessory through a USB interface. Furthermore, the present exemplary embodiments may recognize a type of a connected auxiliary accessory and may automatically perform a function corresponding to the recognized auxiliary accessory. Furthermore, in the present exemplary embodiments, the portable terminal may recognize at least one key input included in the accessory through the USB interface. Accordingly, the user may easily control the portable terminal using at least one key mounted in the accessory.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A system for recognizing an accessory, the system comprising:
the accessory which is connected to a portable terminal through a first Universal Serial Bus (USB) interface unit; and
an auxiliary accessory connected to the accessory through a second USB interface unit or a ear jack interface unit,
wherein the portable terminal senses a connection of the auxiliary accessory to the accessory according to a voltage variation of an identification terminal of a third accessory USB interface unit which is connected to the first USB interface unit.

2. The system of claim 1, wherein the accessory comprises:
the first USB interface unit connected to the portable terminal;
the second USB interface unit to which the auxiliary accessory is connected;
the ear jack interface unit to which an earphone of the auxiliary accessory is connected;
a pull-down resistor for sensing, by the portable terminal, the connection and a type of the accessory; and
an earphone recognition resistor for sensing, by the portable terminal, a connection of an earphone with the ear jack interface unit, and for recognizing a type of the earphone.

3. The system of claim 2, wherein the earphone recognition resistor is disposed between a detection terminal of the ear jack interface unit and the pull-down resistor.

4. The system of claim 3, wherein the detection terminal of the ear jack interface unit is an open circuit when the earphone is not connected, and the detection terminal of the ear jack interface unit is grounded when the earphone is connected.

5. The system of claim 2, wherein the accessory further comprises a key input including a least one key resistor and a switch connected in parallel to the pull-down resistor.

6. The system of claim 1, wherein the portable terminal comprises:
the third USB interface unit to which the first USB interface unit of the accessory is connected;
a controller for sensing a connection of the accessory and the auxiliary accessory and for recognizing a type of the connected accessory and a type of the connected auxiliary accessory through the voltage variation of the identification terminal of the third USB interface unit; and
a memory for storing an accessory recognition table for recognizing the type of the accessory and an auxiliary accessory recognition table for recognizing the type of the auxiliary accessory.

7. The system of claim 6, wherein the controller executes a function according to the recognized auxiliary accessory.

8. The system of claim 6, wherein the controller determines an output voltage of the identification terminal when the auxiliary accessory is connected, and
wherein the controller recognizes that an auxiliary accessory mapped to the output voltage of the identification terminal is connected by using the auxiliary accessory recognition table.

9. The system of claim 8, wherein the controller recognizes a type of the connected auxiliary accessory by using another auxiliary accessory recognition table according to the recognized type of the accessory.

10. The system of claim 6, wherein the controller senses a key input of the accessory according to the voltage variation of the identification terminal,
wherein the controller measures an output voltage of the identification terminal, and
wherein the controller recognizes that a key mapped to the measured output voltage is input via a key recognition table.

11. The system of claim 8, wherein the controller recognizes an input key using another key recognition table according to at least one of the recognized type of the accessory and the recognized type of the auxiliary accessory.

12. A method for recognizing an accessory in a portable terminal to which the accessory is connected via a Universal Serial Bus (USB) interface unit, the method comprising:
sensing a connection of the accessory through an identification terminal of the USB interface unit; and
sensing a connection of an auxiliary accessory according to a voltage variation of the identification terminal when the accessory is connected to the portable terminal

13. The method of claim 12, further comprising recognizing a type of the auxiliary accessory when the connection of the auxiliary accessory is sensed; and
executing a function corresponding to the type of the recognized auxiliary accessory.

14. The method of claim 13, wherein the recognizing of the type of the auxiliary accessory comprises:
determining an output voltage of the identification terminal; and
recognizing that an auxiliary accessory mapped to the output voltage of the identification terminal is connected by using a stored auxiliary accessory recognition table.

15. The method of claim 14, wherein the using of the stored auxiliary accessory recognition table comprises using another auxiliary accessory recognition table according to the recognized type of the accessory.

16. The method of claim 12, further comprising sensing a key input of the accessory according to the voltage variation of the identification terminal.

17. The method of claim 16, wherein the sensing of the key input of the accessory comprises:
determining an output voltage of the identification terminal; and
recognizing that a key mapped to the output voltage of the identification terminal is input by using a stored key recognition table.

18. The method of claim 17, wherein the using of the key recognition table comprises using another key recognition table according to at least one of the recognized type of the accessory and the recognized type of the auxiliary accessory.

19. The method of claim 12, wherein the auxiliary accessory is connected through an ear jack interface unit of the accessory.
